(19) United States
(12) Patent Application Publication
(10) Pub. No.: US 2026/0253497 A1
(43) Pub. Date: Aug. 27, 2026

(54) DETECTING LANE CHANGES USING WAVELET TRANSFORMATIONS

(71) Applicant: TOYOTA MOTOR ENGINEERING & MANUFACTURING NORTH AMERICA, INC., PLANO, TX (US)

(72) Inventors: YASHAR ZEIYNALI FARID, San Jose, CA (US); MARYAM KHABAZI, Mountain View, CA (US); LU XU, Canton, MI (US); CHUNGHAN LEE, Mountain Veiw, CA (US); EMRAH AKIN SISBOT, Menlo Park, CA (US); YUSUKE TAKEUCHI, Cupertino, CA (US); KENTARO OGUCHI, Mountai View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 19/064,194

(22) Filed: Feb. 26, 2025

(51) Int. Cl. G08G 1/16; G06F 18/2131

(52) U.S. Cl. CPC G08G 1/167; G06F 18/2131

(57) ABSTRACT

Systems and methods are provided for detecting lane changes. For example, responsive to determining a vehicle is traversing a road segment comprising a curve, a system of the presently disclosed technology may be configured to apply a wavelet transformation to a vehicle motion signal associated with the vehicle traversing the road segment. The wavelet transformation may decompose the vehicle motion signal into a first wavelet associated with the vehicle traversing the curve and a second wavelet associated with the vehicle changing lanes while traversing the curve. The system may filter out the first wavelet based on historical data, and only analyze the second wavelet to determine the vehicle changed lanes while traversing the curved road segment.

### TECHNICAL FIELD

The present disclosure relates generally to automotive systems and technologies. More particularly, some embodiments relate to detecting lane changes of vehicles.

### DESCRIPTION OF RELATED ART

Various systems rely on (or otherwise benefit from) accurate and rapid detection of lane changes by vehicles.

For example, lane-level traffic map generation systems/lane-level traffic estimation systems can update more rapidly and accurately based on rapidly and accurately detected lane changes. In turn, human drivers (or autonomous driving systems as described below) relying on such lane-level traffic maps/estimations can make more rapid and improved decisions.

As another example, autonomous driving systems can make improved decisions based on rapidly and accurately detected lane changes. For instance, an autonomous driving system may make evasive/safety maneuvers more rapidly or more effectively in response to accurately and rapidly detected lane changes. Relatedly, the autonomous driving system can make maneuvers to improve traffic efficiency on a road segment based on rapidly and accurately detected lane changes. In some cases, such maneuvers may be informed by an above-referenced lane-level traffic map/estimate.

As used herein, a wavelet may refer to a wave-like oscillation with an amplitude that begins at zero, increases or decreases, and then returns to zero one or more times. As such, wavelets are sometimes referred to as brief oscillations, localized in time. In many cases, wavelets are imbued with specific properties that make them useful for signal processing.

As used herein, a wavelet transformation may refer to a technique for transforming/decomposing a signal into the frequency domain as a set of wavelets. Wavelet transformations have been used in various signal processing applications, such as de-noising signals, compressing or de-compressing signal data, etc.

### BRIEF SUMMARY OF THE DISCLOSURE

According to various embodiments of the presently disclosed technology, a method is provided. The method may comprise: (1) transforming a vehicle motion signal into a frequency domain by applying a wavelet transformation to the vehicle motion signal, wherein the vehicle motion signal is associated with a vehicle traversing a road segment; (2) based on historical lane change data, filtering the wavelet-transformed vehicle motion signal to extract a wavelet as a potential lane change event; and (3) providing the extracted wavelet to an analytical model and using the analytical model to determine, based on the extracted wavelet, that the vehicle changed lanes while traversing the road segment.

In some embodiments of the method, the method may further comprise transmitting information associated with the determined lane change to at least one of a lane-level traffic map generation system and an autonomous driving system.

In certain embodiments of the method, the method may comprise at least one of: (a) autonomously controlling at least one of the vehicle and a second vehicle traversing the road segment based on the determined lane change of the vehicle; or (b) updating a lane-level traffic map for the road segment based on the determined lane change of the vehicle.

In various embodiments of the method, filtering the wavelet-transformed vehicle motion signal to extract the wavelet as the potential lane change event may comprise at least one of: (a) extracting the wavelet because it falls within a power range pre-determined from the historical lane change data; (b) extracting the wavelet because it falls within a frequency range pre-determined from the historical lane change data; or (c) extracting the wavelet because it falls within a period range pre-determined from the historical lane change data. In some of such embodiments, the historical lane change data may comprise historical wavelet-transformed vehicle motion signals associated with known lane changes, or more specifically, historical lane change data comprises historical wavelet-transformed vehicle motion signals associated with known lane changes on the road segment.

In various embodiments of the method, transforming the vehicle motion signal into the frequency domain by applying the wavelet transformation to the vehicle motion signal may comprise generating a first wavelet associated with the vehicle traversing a curve on the road segment and a second wavelet associated with the vehicle changing a lane while traversing the curve. Relatedly, filtering the wavelet-transformed vehicle motion signal to extract the wavelet as the potential lane change event may comprise extracting only the second wavelet of the first and second wavelets. In some of such embodiments, the method may further comprise determining the road segment comprises the curve. Accordingly, generating the first wavelet associated with the vehicle traversing the curve and the second wavelet associated with the vehicle changing the lane while traversing the curve may be responsive to determining the road segment comprises the curve.

In certain embodiments of the method, the vehicle motion signal may be derived from at least one of: (i) lateral acceleration data of the vehicle as the vehicle traverses the road segment; (ii) yaw rate data of the vehicle as the vehicle traverses the road segment; (iii) heading data of the vehicle as the vehicle traverses the road segment; (iv) accelerometer data of the vehicle as the vehicle traverses the road segment; (v) steering wheel angle data of the vehicle as the vehicle traverses the road segment; or (vi) speed data of the vehicle as the vehicle traverses the road segment.

In some embodiments of the method, the method may further comprise, responsive to extracting the wavelet as the potential lane change event, providing, to the analytical model, non-wavelet data associated with the vehicle traversing the road segment. Here, the analytical model may also consider the non-wavelet data when determining the vehicle changed lanes while traversing the road segment. In certain of such embodiments, the non-wavelet data associated with the vehicle traversing the road segment may comprise at least one of: (i) turning signal operation data acquired from the vehicle as the vehicle traverses the road segment; (ii) lateral position data acquired from the vehicle as the vehicle traverses the road segment; (iii) image data acquired from the vehicle as the vehicle traverses the road segment; or (iv) image data capturing the vehicle, acquired from other vehicles proximate the vehicle as the other vehicles traverse the road segment with the vehicle. In certain of such embodiments, the image data capturing the vehicle, acquired from the other vehicles, may comprise at least one of: (A) image data capturing operation of a turning signal of the vehicle; or (B) image data capturing lateral position of the vehicle relative to lane boundaries of the road segment.

In various embodiments of the method, the method may further comprise filtering the vehicle motion signal based on historical lane change data to extract potential lane change events characterized by the vehicle motion signal. Relatedly, transforming the vehicle motion signal into the frequency domain by applying the wavelet transformation to the vehicle motion signal may comprise only transforming the extracted potential lane change events characterized by the vehicle motion signal.

In various embodiments of the presently disclosed technology, a system is provided. The system may comprise: (1) one or more processors; and (2) memory storing machine-readable instructions that, when executed by the one or more processors, cause the system to: (a) responsive to determining a vehicle is traversing a road segment comprising a curve, applying a wavelet transformation to a vehicle motion signal associated with the vehicle traversing the road segment to decompose the vehicle motion signal into a first wavelet associated with the vehicle traversing the curve and a second wavelet associated with the vehicle changing lanes while traversing the curve; and (b) analyzing the second wavelet to determine the vehicle changed lanes while traversing the curve.

In some embodiments of the system, the memory may store further machine-readable instructions that, when executed by the one or more processors, cause the system to transmit information associated with the determined lane change to at least one of a lane-level traffic map generation system and an autonomous driving system.

In certain embodiments of the system, the memory may store further machine-readable instructions that, when executed by the one or more processors, cause the system to, at least one of: (i) autonomously control at least one of the vehicle and a second vehicle traversing the road segment based on the determined lane change of the vehicle; or (ii) update a lane-level traffic map for the road segment based on the determined lane change of the vehicle.

In various embodiments of the system, the memory may store further machine-readable instructions that, when executed by the one or more processors, cause the system to, based on historical lane change data, filter out the first wavelet prior to analyzing the second wavelet. In some of such embodiments, filtering out the first wavelet based on the historical lane change data may comprise determining the first wavelet falls outside at least one of: (i) a power range indicative of potential lane change events, the power range pre-determined from the historical lane change data; (ii) a frequency range indicative of potential lane change events, the frequency range pre-determined from the historical lane change data; or (iii) a period range indicative of potential lane change events, the period range pre-determined from the historical lane change data.

In various embodiments of the presently disclosed technology, a second method is provided. The second method may comprise: (1) transforming vehicle motion signals associated with known lane changes performed on curved road segments into a frequency domain by applying a wavelet transformation to the vehicle motion signals; and (ii) using the wavelet-transformed vehicle motion signals to train a machine learning model to detect lane changes performed on curved road segments.

In some embodiments of the second method, transforming a respective vehicle motion signal associated may comprise decomposing the respective vehicle motion signal into a first wavelet associated with a respective vehicle traversing a respective curved road segment and a second wavelet associated with the respective vehicle changing lanes while traversing the respective curved road segment.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict example embodiments.

FIGS. 1A-1C illustrate an example road segment over which embodiments of the presently disclosed technology may be implemented.

FIG. 2 illustrates an example vehicle, in accordance with various embodiments of the presently disclosed technology.

FIG. 3 illustrates an example implementation of a lane change detection system, in accordance with various embodiments of the presently disclosed technology.

FIG. 4 illustrates an example process that may be performed by a lane change detection system to detect lane changes, in accordance with various embodiments of the presently disclosed technology.

FIG. 5 depicts example representations of wavelet-transformed vehicle motion signals transformed using different parameters, in accordance with various embodiments of the presently disclosed technology.

FIGS. 6A-6C depict an example representation of a wavelet-transformed vehicle motion signal, in accordance with various embodiments of the presently disclosed technology.

FIG. 7 depicts an example representation of a wavelet-transformed vehicle motion signal associated with a vehicle changing lanes while traversing a curved road segment, in accordance with various embodiments of the presently disclosed technology.

FIG. 8 illustrates an example lane-level traffic map, in accordance with various embodiments of the presently disclosed technology.

FIG. 9 illustrates an example computing component that may be used to implement various features of embodiments described in the present disclosure.

The figures are not exhaustive and do not limit the present disclosure to the precise form disclosed.

### DETAILED DESCRIPTION

As described above, various systems (e.g., lane-level traffic map generation systems and autonomous driving systems) rely on accurate and rapid detection of lane changes by vehicles.

As such, there are various systems dedicated to detecting lane changes on a road segment. Such lane change detection systems can be implemented on the cloud, on roadside infrastructure adjacent the road segment, across one or more vehicle traversing the road segment, or any combination thereof.

There are various existing lane change detection techniques that can be utilized by lane change detection systems. However, many of these existing lane change detection techniques are impractical for systems that require acquiring data from many different vehicles traversing a road segment (e.g., cloud-based systems) as they rely on: (1) premium and uncommon vehicle sensors; (2) transferring large volumes of data/large size signals (such as image data); or (3) some combination of (1) and (2).

For example, certain existing lane change detection techniques rely on vehicles' high-precision GPS sensors (or high-precision maps derived therefrom) to detect lane changes. However, high-precision GPS sensors are generally expensive, and (relatedly) many existing connected vehicles are not equipped with them. Accordingly, it can be impractical/infeasible for systems to detect lane changes via high-precision GPS-based techniques where only a subset of vehicles have the requisite sensors to support them. Relatedly, in various scenarios a high-precision GPS signal may be compromised due to noise/physical obstructions, which can further limit performance for high-precision GPS-based lane change detection techniques.

Other existing lane change detection techniques rely on image data (e.g., image data capturing a vehicle's lateral position relative to lane boundaries) acquired from vehicle cameras/image sensors. However, such image data can be voluminous due in part to large signal size, and thus can be cumbersome to transfer. This can make it somewhat infeasible/impractical to utilize image data-based techniques in lane change detection systems (e.g., cloud-based systems) where data is being acquired from many different vehicles traversing a road segment.

As embodiments of the presently disclosed technology are designed in appreciation of, lane change detection techniques that utilize vehicle motion signals present a promising alternative to the above-described lane change detection techniques involving high-precision GPS and image data.

This is in part because vehicle motion signal-based lane change detection techniques can rely on less premium and more common vehicle sensors (e.g., lateral acceleration sensors, heading sensors, yaw rate sensors, accelerometers, steering wheel angle sensors, speed sensors, or some combination thereof). Moreover, vehicle motion signals are typically smaller/less voluminous, and thus easier and faster to transfer than image data. As such, vehicle motion signal-based techniques are theoretically more practical to implement for many lane change detection systems as a larger number of vehicles are equipped to support them and the utilized signals/data are easier to transfer.

However, a shortcoming of vehicle motion signal-based lane change detection techniques is that they can be less accurate on curved road segments. For example, existing vehicle motion signal-based lane change detection techniques may incorrectly detect/determine a vehicle changed lanes on a curved road segment because a vehicle motion signal (e.g., a lateral acceleration signal) acquired from the vehicle while traversing the curved road segment was highly similar to vehicle motion signals that would indicate the vehicle changed lanes on a straight road segment. Relatedly, existing vehicle motion signal-based lane change detection techniques may incorrectly detect/determine a vehicle did not change lanes on a curved road segment because a vehicle motion signal acquired from the vehicle while changing lanes on the curved road segment was highly similar to vehicle motion signals that would indicate the vehicle did not change lanes on a straight road segment.

Against this backdrop, the presently disclosed technology provides improved lane change detection systems and methods that utilize vehicle motion signals in a manner that may be implemented to account for curved road segments. For example, responsive to determining a vehicle is traversing a curved road segment, a system of the presently disclosed technology can apply a wavelet transformation to a vehicle motion signal associated with the vehicle traversing the curved road segment. Parameters of the wavelet transformation can be tuned to clearly decompose the vehicle motion signal into a first wavelet associated with the vehicle traversing the curve and a second wavelet associated with the vehicle changing lanes while traversing the curve.

The system can then individually analyze the decomposed wavelets to determine the vehicle changed lanes while traversing the curve/curved road segment. For example, the system can determine one or more characteristics of the second wavelet (e.g., wavelet power, wavelet frequency/wavelet frequency range, wavelet period/wavelet duration, etc.) fall within pre-determined ranges indicative of a lane change based on historical lane change data (e.g., historical wavelet-transformed vehicle motion signals associated with known lane changes). In some implementations, the system can utilize a trained machine learning model to perform such analysis.

In some implementations, the presently disclosed technology can further improve the functioning of associated computing systems (e.g., computerized lane-detection systems, autonomous driving systems relying on rapid detection of lane changes, computerized lane-level traffic map generation systems, etc.) by enhancing processing speed and efficiency by filtering wavelet-transformed vehicle motion signals based on historical lane change data to extract a subset of wavelets as potential lane change events. For example, a presently disclosed computing system can extract one or more wavelets from a wavelet-transformed vehicle motion signal because they fall within a pre-determined range for a particular wavelet characteristic known to be indicative of potential lane change events. Accordingly, the computing system can enhance processing speed and efficiency by limiting further analysis of the wavelet-transformed vehicle motion signal to the extracted wavelets/potential lane change events—as opposed to further analyzing the entire wavelet-transformed vehicle motion signal.

Examples of the above-described wavelet characteristic may include at least one of: (a) wavelet power; (b) wavelet frequency/wavelet frequency range; or (c) wavelet period/wavelet duration. The pre-determined range for the wavelet characteristic that is indicative of a potential lane change event can be determined using historical ground truth data—such as historical wavelet-transformed vehicle motion signals associated with known lane changes. In certain implementations, the system can utilize machine learning to determine such a range.

Accordingly, the presently disclosed systems and methods can detect lane changes (or non-lane changes) on curved road segments more accurately, and more efficiently (e.g., with fewer processing resources, with less processing time, with smaller volumes of signals/data transmitted, etc.) than existing vehicle motion signal-based lane change detection technologies.

Moreover, the presently disclosed systems and methods can be more practical and less expensive to implement than existing/alternative lane change detection technologies that rely on high-precision GPS or image data. As discussed above, vehicle motion signal-based lane change detection techniques can utilize less premium and more common vehicle sensors (e.g., lateral acceleration sensors, heading sensors, yaw rate sensors, accelerometers, steering wheel angle sensors, speed sensors, or some combination thereof). Relatedly, vehicle motion signals are typically smaller/less voluminous, and thus easier to transfer than image data. As such, the presently disclosed vehicle motion signal-based techniques can be more practical to implement than alternative high-precision GPS or image data-based techniques as a larger number of vehicles are equipped to support them and the utilized signals/data are easier to transfer.

The presently disclosed lane change detection systems and methods can also be incorporated into, and thus improve, related technological systems.

For example, in certain implementations the presently disclosed lane change detection systems and method may be incorporated into (or otherwise integrate/interoperate with) autonomous driving systems to control vehicles based on detected lane changes. As such, the presently disclosed lane change detection systems and methods can improve the function/operation of the autonomous driving systems by facilitating more rapid and improved decision making. Relatedly, the presently disclosed lane change detection systems and methods can improve such autonomous driving systems' control of vehicles in response to detected lane changes. In turn, these more rapid and improved decisions/vehicle control can improve traffic safety and efficiency.

As another example, in some implementations the presently disclosed lane change detection systems and method may be incorporated into (or otherwise interoperate with) lane-level traffic map generation/estimation systems to update lane-level traffic maps/estimations in real-time based on detected lane changes. As such, the presently disclosed lane change detection systems and methods can improve the function/operation of the lane-level traffic map generation/estimation systems by facilitating more rapid and accurate updates to lane-level traffic maps/estimations. In turn, these more rapid and accurate lane-level traffic map/estimation updates can inform human drivers and autonomous driving systems to make more rapid and improved decisions, thus also improving traffic safety and efficiency.

Systems and methods are described in greater detail in conjunction with the following Figures.

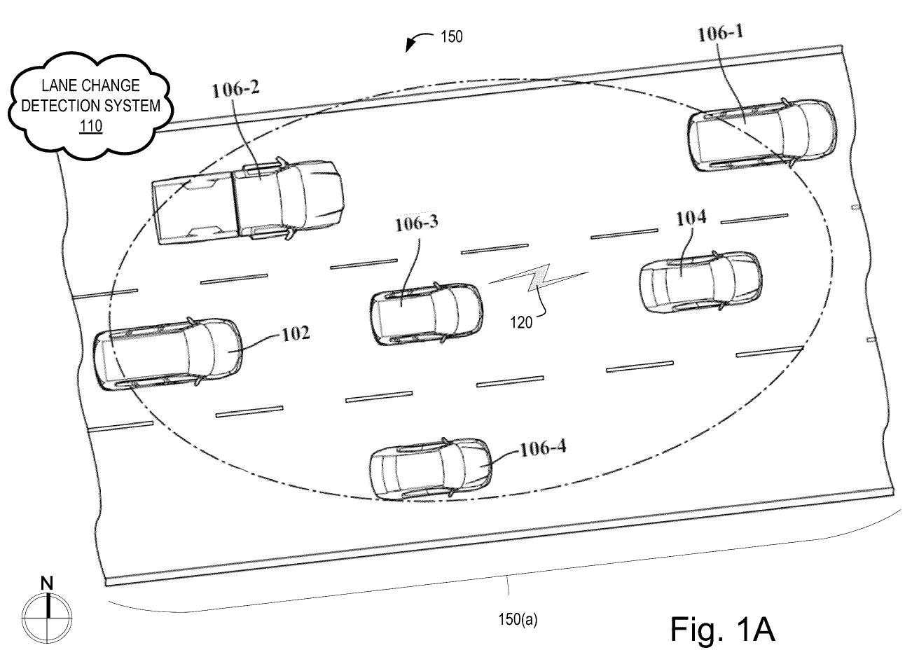

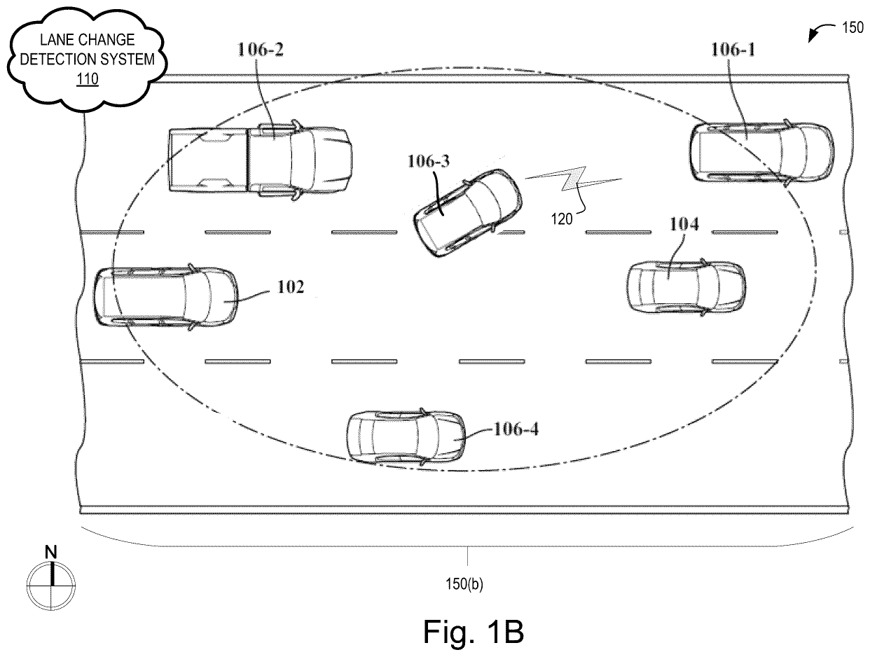

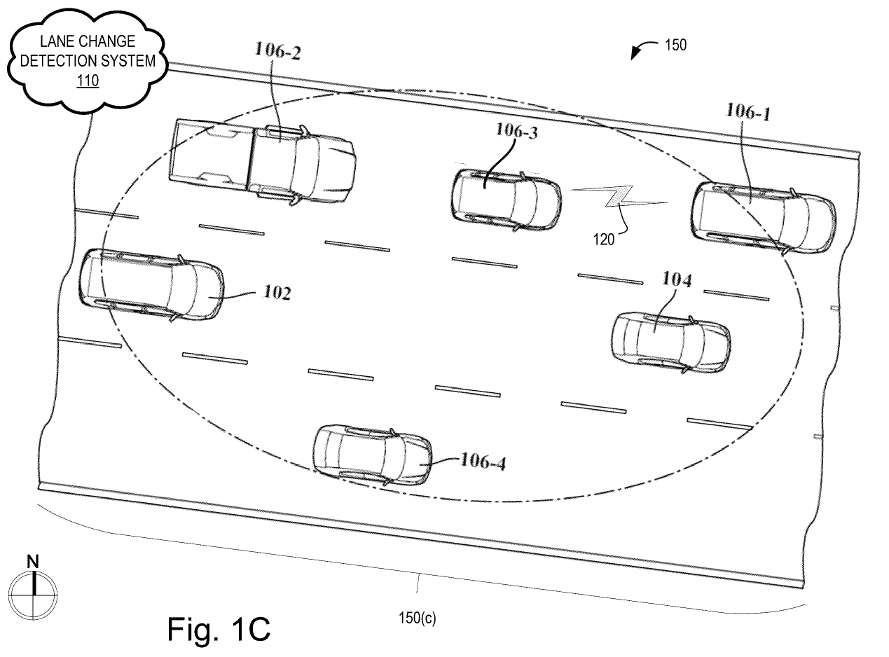

FIGS. 1A-1C illustrate regions of a road segment 150 over which embodiments of the presently disclosed technology may be implemented.

Namely, FIG. 1A illustrates an example region 150(a) that vehicles 102, 104, 106-1, 106-2, 106-3 and 106-4 traverse at a first time t₁. FIG. 1B illustrates an example region 150(b) that the above-referenced vehicles traverse at a later time t₂. FIG. 1C illustrates an example region 150(c) that the above-referenced vehicles traverse at a later time t₃.

As depicted via the relative north-eastward heading of region 150(a), the eastward heading of region 150(b), and the south-eastward heading of region 150(c), road segment 150 may comprise a curved road segment (i.e., a road segment with a curve).

As also depicted, vehicle 106-3 may change lanes while traversing the curve of road segment 150 (i.e., from the middle lane to the left lane) between time t₁ and t₃.

As depicted, vehicle 106-3 may communicate with a lane change detection system 110. In certain implementations, lane change detection system 110 may be implemented as a cloud-based system. In other implementations, lane change detection system 110 may be implemented on roadside infrastructure adjacent road segment 150, or across one or more of vehicles 102, 104, 106-1, 106-2, 106-3 and 106-4. In still further implementations, lane change detection system 110 may be implemented across any combination of the cloud, roadside infrastructure adjacent road segment 150, and one or more of vehicles 102, 104, 106-1, 106-2, 106-3 and 106-4.

Vehicle 106-3 can transmit (and lane change detection system 110 can acquire) a vehicle motion signal 120 as vehicle 106-3 traverses road segment 150. Vehicle motion signal 120 may be associated with various types of vehicle motion characteristics. For example, vehicle motion signal 120 may comprise at least one of: (a) a lateral acceleration signal of vehicle 106-3 as vehicle 106-3 traverses road segment 150; (b) a yaw rate signal of vehicle 106-3 as vehicle 106-3 as traverses road segment 150; (c) a heading signal of vehicle 106-3 as vehicle 106-3 traverses road segment 150; (d) an accelerometer signal of vehicle 106-3 as vehicle 106-3 traverses road segment 150; (e) a steering wheel angle signal of vehicle 106-3 as vehicle 106-3 traverses road segment 150; or (f) a speed signal of vehicle 106-3 as vehicle 106-3 traverses road segment 150.

As described above, transferring vehicle motion signal 120 can be significantly less cumbersome than transmitting other signals/forms of data, such as image data derived from cameras/image sensors of vehicle 106-3. Thus, by determining lane changes using wavelet-transformed vehicle motion signals, lane change detection system 110 can consume fewer communication and memory resources than alternative systems that rely on transferring larger signals/larger volumes of data (e.g., image data-based systems).

Equipping vehicle 106-3 with sensors that capture vehicle motion-related signals/data is also generally less expensive than equipping vehicle 106-3 with high-precision GPS sensors. Relatedly, sensors that capture vehicle motion-related signals/data are generally more common on connected vehicles than more expensive, high-precision GPS sensors. Thus, by determining lane changes using wavelet-transformed vehicle motion signals, lane change detection system 110 can may be compatible with a wider range of different vehicles than alternative systems that rely on more premium / uncommon sensors.

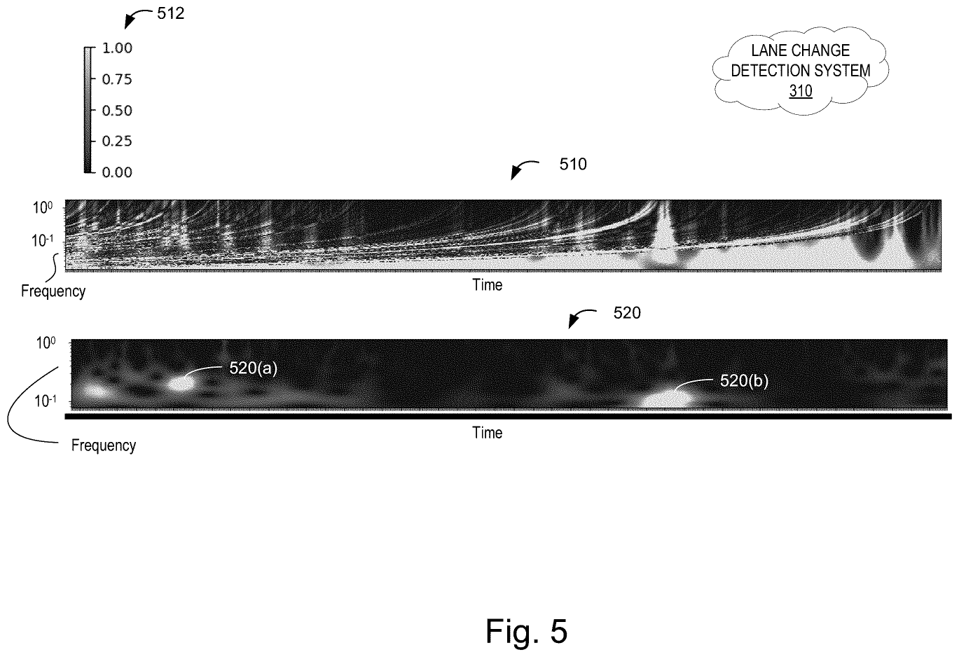

As described above, lane change detection system 110 can transform vehicle motion signal 120 into a frequency domain by applying a wavelet transformation to vehicle motion signal 120 (see e.g., FIGS. 5, 6A-6C and 7 for example representations of wavelet-transformed vehicle motion signals). In some implementations, lane change detection system 110 can perform this transformation in response to determining vehicle 106-3 is traversing curved road segment (e.g., road segment 150). In some implementations, lane change detection system 110 can correlate real-time GPS data of vehicle 106-3 (this may be relatively low precision GPS data derived from more common/lower precision GPS sensors equipped on vehicle 106-3) to map data to determine vehicle 106-3 is traversing the curved road segment (e.g., road segment 150).

Accordingly, lane change detection system 110 can apply a wavelet transformation to vehicle motion signal 120 to decompose vehicle motion signal 120 into a first wavelet associated vehicle 106-3 traversing the curve of road segment 150 and a second wavelet associated with vehicle 106-3 changing lanes while traversing the curve.

As described above, in certain implementations lane change detection system 110 can filter wavelet-transformed vehicle motion signal 120 to extract a subset of wavelets as potential lane change events based on historical lane change data. In some implementations, this may comprise at least one of: (a) extracting one or more wavelets because they fall within a power range pre-determined from the historical lane change data; (b) extracting one or more wavelets because they fall within a frequency range pre-determined from the historical lane change data; or (c) extracting one or more wavelets because they fall within a period/duration range pre-determined from the historical lane change data. As alluded to above, the historical lane change data may comprise historical wavelet-transformed vehicle motion signals associated with known lane changes (sometimes referred to herein as ground-truth data or historical ground-truth data).

As described above, applying the wavelet transformation to vehicle motion signal 120 may decompose vehicle motion signal 120 into a first wavelet associated vehicle 106-3 traversing the curve of road segment 150 and a second wavelet associated with vehicle 106-3 changing lanes while traversing the curve. Accordingly, the above-described filtering may involve extracting only the second wavelet of the first and second wavelets.

Upon filtering the subset of wavelets as potential lane change events, lane change detection system 110 can perform further analysis on them to determine whether any of the wavelets are in fact associated with a lane change. In some implementations, lane change detection system 110 can utilize a trained machine learning model to perform this analysis. Relatedly, in certain implementations the trained machine learning model may consider non-wavelet data associated with vehicle 106-3 traversing road segment 150. Examples of such non-wavelet data may include any one or combination of: (a) a turning signal operation data acquired from vehicle 106-3 as vehicle 106-3 traverses the road segment 150; (b) lateral position data acquired from vehicle 106-3 as vehicle 106-3 traverses road segment 150; (c) image data acquired from vehicle 106-3 as vehicle 106-3 traverses road segment 150; or (d) image data capturing vehicle 106-3, acquired from other vehicles proximate vehicle 106-3 (e.g., vehicle 102, vehicle 104, etc.) as the other vehicles traverse road segment 150 with vehicle 106-3. Here, the image data acquired from the other vehicles proximate vehicle 106-3 may comprise at least one of: (i) image data capturing operation of a turning signal of vehicle 106-3; or (ii) image data capturing lateral position of vehicle 106-3 relative to lane boundaries of road segment 150.

In various implementations, responsive to determining vehicle 106-3 changed lanes while traversing road segment 150, lane change detection system 110 can at least one of: (1) autonomously control at least one of vehicles 102, 104, 106-1, 106-2, 106-3 and 106-4 based on the determined lane change of vehicle 106-3; or (2) update a lane-level traffic map for road segment 150 based on the determined lane change of vehicle 106-3. In other implementations, lane change detection system 110 can instead provide the lane change determination to one or more autonomous driving systems implemented on the vehicles traversing road segment 150. In still further implementations lane change detection system 110 can provide the lane change determination to a lane-level traffic map generation system—which in turn updates a lane-level traffic map. The above-described autonomous driving systems, as well as human drivers, may then make improved decisions based on the updated lane-level traffic map.

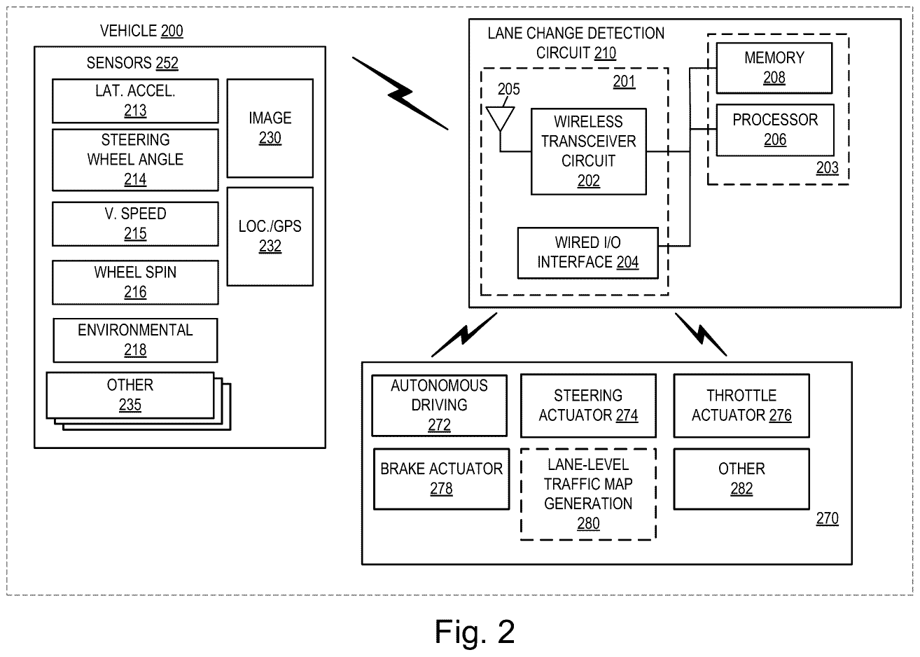

FIG. 2 illustrates an example vehicle 200, in accordance with various embodiments of the presently disclosed technology. Vehicle 200 may be an example of any of the vehicles depicted and described in conjunction with FIGS. 1A-1C.

As depicted, vehicle 200 comprises a lane change detection circuit 210, sensors 252, and additional vehicle systems 270. Sensors 252 and additional vehicle systems 270 can communicate with lane change detection circuit 210 via a wired or wireless communication interface. Although sensors 252 and additional vehicle systems 270 are depicted as communicating with lane change detection circuit 210, they can also communicate with each other. Lane change detection circuit 210 can be implemented as an electronic control unit (ECU) or as part of an ECU. In other embodiments, lane change detection circuit 210 can be implemented independently of an ECU.

In the specific example of FIG. 2, lane change detection circuit 210 includes a communication circuit 201 and a decision circuit 203 (including a processor 206 and a memory 208). Components of lane change detection circuit 210 are illustrated as communicating with each other via a data bus, although other interfaces can be included.

Processor 206 can include one or more general processing units (GPUs), central processing units (CPUs), microprocessors, or any other suitable processing system. Processor 206 may include a single core processor or multicore processors. Memory 208 can be made up of one or more modules of one or more different types of memory (e.g., flash, RAM, etc.) that may be used to store data related to lane change detection algorithms, data related to detecting lane changes, statistical model parameters, data/information related to mother wavelet functions/wavelet families and parameters thereof, instructions and variables for processor 206, as well as any other suitable information.

Although the example of FIG. 2 is illustrated using processor and memory circuitry, in various embodiments decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up lane change detection circuit 210.

Communication circuit 201 can utilize a wireless transceiver circuit 202 with an associated antenna 205 for wireless communication. Communication circuit 201 can also utilize a wired I/O interface 204 with an associated hardwired data port (not illustrated). As this example illustrates, communications with lane change detection circuit 210 can include either or both wired and wireless communications. Wireless transceiver circuit 202 can include a transmitter and a receiver to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and can be used by wireless transceiver circuit 202 to transmit radio signals wirelessly to wireless equipment and to receive radio signals as well. These radio signals can include information of almost any sort that is sent or received by lane change detection circuit 210 to/from other entities such as sensors 252, additional vehicle systems 270, other vehicles, connected roadside infrastructure, cloud computing entities, remote servers, etc.

Wired I/O interface 204 may include a transmitter and a receiver for hardwired communications with other devices. For example, wired I/O interface 204 can provide a hardwired interface to other components, including sensors 252 and additional vehicle systems 270. Wired I/O interface 204 can communicate with other devices using Ethernet or any of a number of other wired communication protocols whether standardized, proprietary, open, point-to-point, networked or otherwise.

In certain implementations, decision circuit 203 and communication circuit 201 may be used for computation, memory, or communication tasks beyond lane change detection. In some implementations, vehicle 200 may comprise additional processing, memory, or communication resources (not depicted) devoted to these other tasks.

Sensors 252 can include, for example, lateral acceleration sensor(s) 213, heading sensor(s) 214, yaw rate sensor(s) 215, accelerometer(s) 216, steering wheel angle/position sensor(s) 217 (e.g., one or more sensors to detect angle/position of a steering wheel of vehicle 200), and vehicle speed sensor(s) 218 (e.g., one or more sensors to detect speed of vehicle 200). Sensors 252 may also include wheelspin sensor(s) 219 (e.g., one for each wheel), environmental sensor(s) 220 (e.g., to detect salinity or other environmental conditions), image sensor(s) 230, and location sensor(s) 232. Other sensors 235 can also be included as may be appropriate for a given implementation of vehicle 200. For example, other sensors 235 may include proximity sensors such as radar sensors, LiDAR sensors, sonar sensors, etc.

In some embodiments, image sensor(s) 230 may comprise one or more cameras (e.g., monocular cameras, stereoscopic cameras, RGB cameras, infrared cameras, etc.) configured to obtain image data of an environment surrounding vehicle 200. As discussed above, in certain implementations such image data can be used to verify/determine a lane change for an identified potential lane change event.

In certain embodiments, location sensor(s) 232 may comprise a global navigation satellite sensor, a global position sensor, or other types of vehicle positioning sensors. Location sensor(s) 232 may be configured to generate location data for vehicle 200 and/or location data for landmarks in the environment surrounding vehicle 200 (e.g., intersections or corners of a road). The location data may comprise approximate coordinates (e.g., latitude, longitude, and altitude) of vehicle 200's position on the Earth's surface. As discussed above, in certain implementations such location data can be used to determine vehicle 200 is traversing a curved road segment.

In some embodiments, one or more of sensors 252 may include their own processing capability to compute the results for additional information that can be provided to lane change detection circuit 210. In other embodiments, one or more of sensors 252 may be data-gathering-only sensors that only provide raw data signals to lane change detection circuit 210. In further embodiments, one or more hybrid sensors may be included that provide a combination of raw data signals and processed data signals to lane change detection circuit 210. Sensors 252 may provide analog outputs, digital outputs, or a combination of both.

Additional vehicle systems 270 can include any of a number of different vehicle components or subsystems used to control or monitor various aspects of vehicle 200 and its performance. For example, additional vehicle systems 270 may include any one or combination of an autonomous driving system 272, a steering actuator 274, a throttle actuator 276, a brake actuator 278, a lane-level traffic map generation system 280 and other vehicle systems 282. Here other vehicle systems 282 may comprise various other types of vehicle systems utilized in the operation of vehicle 200.

As alluded to above, in certain implementations, lane change detection circuit 210 can provide a detected/determined lane change to autonomous driving system 272. In turn, autonomous driving system 272 can autonomously control vehicle 200 based on the detected/determined lane change using one or more of steering actuator 274, throttle actuator 276 and brake actuator 278. In some implementations, lane change detection circuit 210 can additionally (or alternatively) provide the detected/determined lane change to lane-level traffic map generation system 280. In turn, lane-level traffic map generation system 280 can update a lane-level traffic map based on the detected/determined lane change. In some of such implementations, autonomous driving system 272 can use the updated lane-level traffic map to make improved decisions (e.g., changing lanes to avoid a traffic back-up, changing lanes to avoid a potential collision, etc.).

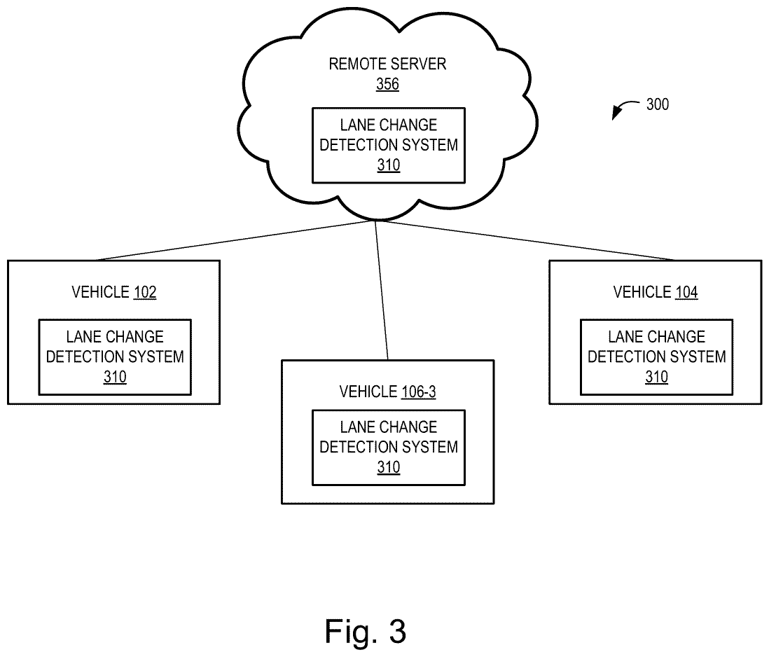

FIG. 3 depicts an example lane change detection system 310, in accordance with various embodiments of the presently disclosed technology. Lane change detection system 310 be an example of lane change detection system 110 from FIGS. 1A-1C.

As depicted in FIG. 3, in some embodiments lane change detection system 310 may be implemented across a remote server 356 and one or more vehicles traversing a road segment, such as vehicle 102, vehicle 104, and vehicle 106-3 from FIGS. 1A-1C. Such embodiments may be facilitated by a remote environment 300. In some embodiments, remove environment 300 may comprise a cloud-based environment. In other embodiments, remote environment 300 may comprise an edge-based environment. Such an edge-based environment can utilize various types of edge infrastructure, such as roadside/traffic infrastructure, cellular network infrastructure, etc. In some implementations, remote environment 300 may be a combination of a cloud-based environment and an edge-based environment.

Accordingly, lane change detection system 310 may include separate instances within one or more entities of remote environment 300, such as remote server 356, vehicle 102, vehicle 104, and vehicle 106-3. In a further aspect, the entities that implement lane change detection system 310 within remote environment 300 may vary beyond transportation-related devices and encompass roadside infrastructure elements. Thus, the set of entities that function in coordination with remote environment 300 may be varied.

In some embodiments, remote environment 300 itself may comprise a dynamic environment that comprises cloud members that migrate into and out of a geographic area.

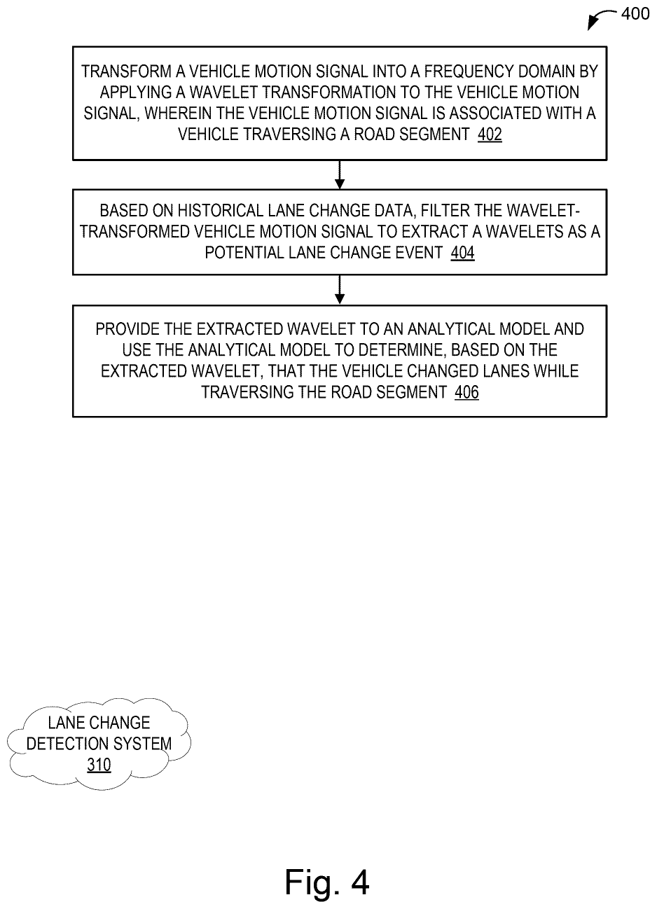

FIG. 4 illustrates an example process 400 that may be performed by lane change detection system 310 to detect lane changes, in accordance with various embodiments of the presently disclosed technology.

As depicted, lane change detection system 310 can perform operation 402 to transform a vehicle motion signal into a frequency domain by applying a wavelet transformation to the vehicle motion signal.

The vehicle motion signal may be associated with a vehicle traversing a road segment. In some implementations, the vehicle motion signal may comprise at least one of: (a) a lateral acceleration signal of the vehicle as the vehicle traverses the road segment; (b) a yaw rate signal of the vehicle as the vehicle as traverses the road segment; (c) a heading signal of the vehicle as the vehicle traverses the road segment; (d) an accelerometer signal of the vehicle as the vehicle traverses the road segment; (e) a steering wheel angle signal of the vehicle as the vehicle traverses the road segment; or (f) a speed signal of the vehicle as the vehicle traverses the road segment. In other implementations, the vehicle motion signal may be more generally derived from: (a) lateral acceleration data of the vehicle as the vehicle traverses the road segment; (b) yaw rate data of the vehicle as the vehicle traverses the road segment; (c) heading data of the vehicle as the vehicle traverses the road segment; (d) accelerometer data of the vehicle as the vehicle traverses the road segment; (e) steering wheel angle data of the vehicle as the vehicle traverses the road segment; or (f) speed data of the vehicle as the vehicle traverses the road segment.

As described above, in certain implementations, lane change detection system 310 can perform operation 402 in response to determining the vehicle is traversing a road segment comprising a curve (in other words, in response to determining the road segment comprises a curve). In certain implementations, lane change detection system 310 can make this determination by correlating real-time GPS data of the vehicle (this may be relatively low precision GPS data derived from more common/lower precision GPS sensors equipped on the vehicle) to map data to determine the vehicle is traversing a curved road segment/a road segment comprising a curve.

As such, performing operation 402 may comprise applying the wavelet transformation to the vehicle motion signal to decompose the vehicle motion signal into a first wavelet associated with the vehicle traversing the curve and a second wavelet associated with the vehicle changing lanes while traversing the curve.

Based on historical lane change data, lane change detection system 310 can perform operation 404 to filter the wavelet-transformed vehicle motion signal to extract a wavelet as a potential lane change event (in some scenarios this may involve extracting multiple wavelets as potential lane change events). As described above, in certain implementations this may comprise at least one of: (a) extracting the wavelet because it falls within a power range pre-determined from the historical lane change data; (b) extracting the wavelet because it falls within a frequency range pre-determined from the historical lane change data; or (c) extracting the wavelet because it falls within a period/duration range pre-determined from the historical lane change data. In certain implementations, the historical lane change data may comprise historical wavelet-transformed vehicle motion signals associated with known lane changes, or more particularly, wavelet-transformed vehicle motion signals associated with known lane changes on the road segment.

As described above, in some implementations, transforming the vehicle motion signal may comprise generating a first wavelet associated with the vehicle traversing a curve on the road segment and a second wavelet associated with the vehicle changing a lane while traversing the curve. Accordingly, in some of such implementations filtering the wavelet-transformed vehicle motion signal to extract the wavelet as a potential lane change event may comprise extracting only the second wavelet of the first and second wavelets.

While not depicted in the specific example of FIG. 4, in some implementations lane change detection system 310 can perform an operation to filter the vehicle motion signal based on historical lane change data before applying the wavelet transformation to the vehicle motion signal. For example, lane change detection system 310 can: (a) filter the vehicle motion signal based on historical lane change data to extract potential lane change events characterized by the vehicle motion signal; and (b) only transform (via the wavelet transformation) the extracted potential lane change events characterized by the vehicle motion signal. Such “pre-transformation” filtering can conserve processing/memory resources associated with the wavelet transformation. The above-described “pre-transformation” filtering may involve extracting portions of the vehicle motion signal because they fall within a pre-determined range for a particular vehicle motion characteristic (e.g., lateral acceleration, yaw angle rate, change in steering wheel angle, etc.) known to be indicative of potential lane change events.

As depicted, lane change detection system 310 can perform operation 406 to provide the extracted wavelet to an analytical model (e.g., a trained machine learning model) and use the analytical model to determine, based on the extracted wavelet, that the vehicle changed lanes while traversing the road segment.

In certain implementations, lane change detection system 310 can also provide non-wavelet data to the analytical model to supplement the analysis. In some of such implementations, such non-wavelet data may be provided in response to lane change detection system 310 extracting a wavelet as a potential lane change event. This selective provision can conserve communication/processing/memory resources.

Examples of the non-wavelet data the analytical model may also consider when determining the vehicle changed lanes while traversing the road segment may include any one or combination of: (a) turning signal operation data acquired from the vehicle as the vehicle traverses the road segment; (b) lateral position data acquired from the vehicle as the vehicle traverses the road segment; (c) image data acquired from the vehicle as the vehicle traverses the road segment; or (d) image data capturing the vehicle, acquired from other vehicles proximate the vehicle as the other vehicles traverse the road segment with the vehicle. In some implementations, the image data capturing the vehicle, acquired from the other vehicles, may comprises at least one of: (i) image data capturing operation of a turning signal of the vehicle; or (ii) image data capturing lateral position of the vehicle relative to lane boundaries of the road segment.

While not depicted in the specific example of FIG. 4, in certain implementations lane change detection system 310 can perform an additional operation to transmit information associated with the determined lane change (from operation 406) to at least one of a lane-level traffic map generation system and an autonomous driving system. In other implementations, lane change detection system 310 can perform an operation to (directly) at least one of: (1) autonomously control at least one of the vehicle and a second vehicle traversing the road segment based on the determined lane change of the vehicle; or (2) update a lane-level traffic map for the road segment based on the determined lane change of the vehicle.

While not depicted in the specific example of FIG. 4, in some implementations lane change detection system 310 can perform operations to train the analytical model/machine learning model to detect lane changes performed on curved road segments. For example, lane change detection system 310 can: (1) transform vehicle motion signals associated with known lane changes performed on curved road segments into a frequency domain by applying a wavelet transformation to the vehicle motion signals; and (2) use the wavelet-transformed vehicle motion signals to train the analytical model/machine learning model to detect lane changes performed on curved road segments. As described above, transforming a respective vehicle motion signal may comprise decomposing the respective vehicle motion signal into a first wavelet associated with a respective vehicle traversing a respective curved road segment and a second wavelet associated with the respective vehicle changing lanes while traversing the respective curved road segment.

FIG. 5 depicts two example representations of wavelet-transformed vehicle motion signals transformed using different parameters, in accordance with various embodiments of the presently disclosed technology. As depicted, these representations may be generated by lane change detection system 310.

Representation 510 illustrates a first wavelet-transformed vehicle motion signal. Representation 520 illustrates a second wavelet-transformed vehicle motion signal. In the specific example of FIG. 5, the first and second wavelet-transformed vehicle motion signals may comprise a common (i.e., the same) vehicle motion signal transformed under a first and second set of wavelet transformation parameters respectively (discussed in more detail below).

As depicted, both representations plot wavelet frequency (depicted on the y-axes) over time (depicted on the x-axes). Color gradient on the two representations is used to depict wavelet power. Legend 512 illustrates a color gradient-to-power legend for representations 510 and 520. As depicted, a lighter color corresponds with a relatively higher wavelet power, and vice versa.

In the specific example of FIG. 5, both the first and second wavelet-transformed vehicle motion signals were transformed using a common (i.e., the same) mother wavelet function (sometimes referred to as wavelet family function)—namely the Complex Morlet Wavelet function. It may be appreciated however that in other implementations different mother wavelet functions may be used (e.g., Haar, Daubechies Biorthogonal, Coiflets, Symlets, Mexican Hat, Meyer, etc.). Through intelligent selection of mother wavelet function, lane change detection system 310 can more clearly decompose a vehicle motion signal into distinct wavelets associated with curve traversals and lane changes respectively.

In the specific example of FIG. 5, different parameters for the Complex Morlet Wavelet function were used to generate the first and second wavelet-transformed vehicle motion signals respectively. Namely, a first set of parameters (e.g., a first value for center frequency and a first value for bandwidth) were used to generate the first wavelet-transformed vehicle motion signal illustrated by representation 510. By contrast, a second set of parameters (e.g., a second value for center frequency and a second value for bandwidth) were used to generate the second wavelet-transformed vehicle motion signal illustrated by representation 520.

As depicted, the second set of wavelet transformation parameters were more effective at de-noising the vehicle motion signal—thus producing more distinct wavelets that can be analyzed more easily. Accordingly, lane change detection system 310 may utilize the second wavelet-transformed vehicle motion signal (visually illustrated by representation 520) when further analyzing whether a lane change occurred. Relatedly, lane change detection system 310 may learn that the second set of wavelet transformation parameters are better suited for wavelet transformations on this particular road segment.

In sum, through intelligent selection of mother wavelet function and parameters thereof, lane change detection system 310 can more effectively de-noise a vehicle motion signal/more clearly decompose the vehicle motion signal into distinct wavelets associated with curve traversals and lane changes respectively.

Moreover, through intelligent bounding of parameters for the generated wavelet-transformed vehicle motion signals, lane change detection system 310 can filter wavelets more easily.

For example, and as illustrated by representations 510 and 520, the first and second wavelet-transformed vehicle motion signals have an upper bound on wavelet power—i.e., where all wavelet powers above the upper bound are represented using the upper bound wavelet power.

Both wavelet-transformed vehicle motion signals also have upper and lower bounds on wavelet frequency. However, the lower bound for wavelet frequency for the second wavelet-transformed vehicle motion signal (approximately 10⁻¹) is higher than the lower bound for wavelet frequency for the first wavelet-transformed vehicle motion signal (a value closer to zero than 10⁻¹).

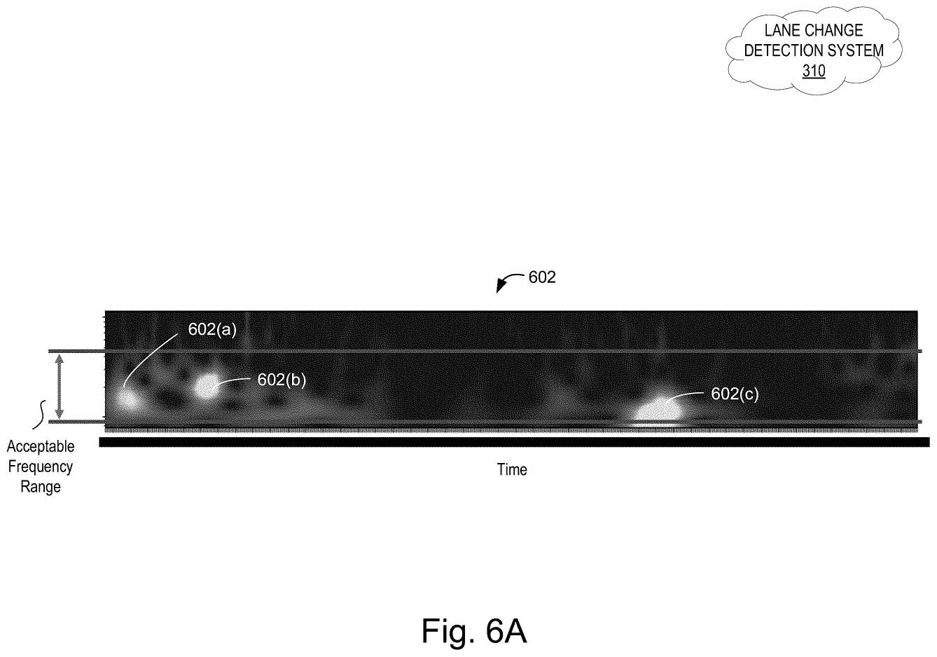

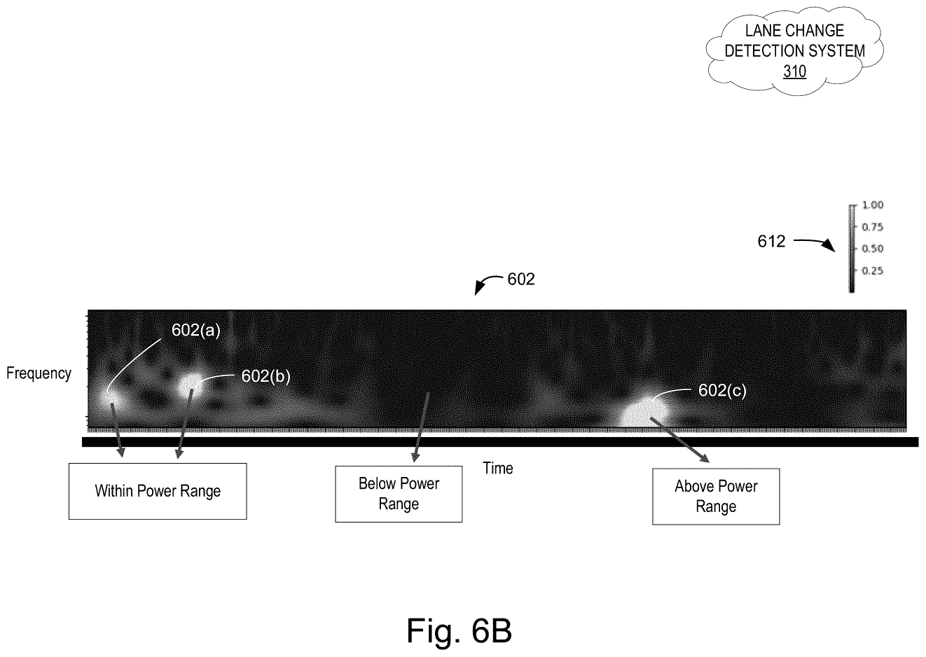

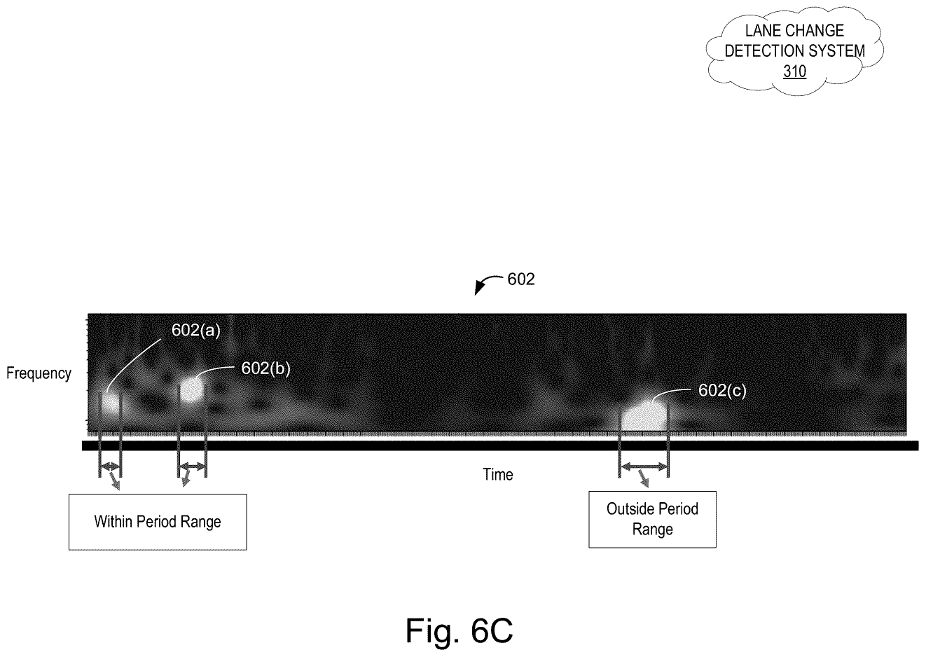

The above-described bounding can make the filtering of wavelets (described in conjunction with FIGS. 6A-6C below) easier for lane change detection system 310 (e.g., with more rapid processing times/less compute load required, etc.).

FIGS. 6A-6C depict an example representation 602 of a wavelet-transformed vehicle motion signal, in accordance with various embodiments of the presently disclosed technology. In certain implementations, lane change detection system 310 can generate representation 602 and the wavelet-transformed vehicle motion signal.

Representation 602 depicts three wavelets—i.e., a wavelet 602(a), a wavelet 602(b), and a wavelet 602(c). As depicted, wavelets 602(a) and 602(b) may comprise approximately the same frequency/frequency range, approximately the same power, and approximately the same period/duration. By contrast, wavelet 602(c) may have a relatively lower frequency/frequency range, a relatively higher power, and a relatively longer period/duration. As such, wavelets 602(a) and 602(b) may be associated with lane changes while wavelet 602(c) may be associated with a vehicle traversing a curved road segment.

FIGS. 6A-6C also illustrate how lane change detection system 310 can filter the wavelet-transformed vehicle motion signal to extract one or more of wavelets 602(a)-(c) as potential lane change events.

Namely, FIG. 6A illustrates how lane change detection system 310 can filter the wavelet-transformed vehicle motion signal using a frequency range pre-determined to indicate potential lane changes. Accordingly, lane change detection system 310 can extract wavelets that fall within this pre-determined frequency range (i.e., wavelets 602(a) and 602(b)) while removing wavelets (i.e., wavelet 602(c)) that fall outside (in whole in part) this pre-determined frequency range. Accordingly, lane change detection system 310 can conserve processing/memory/communication resources by only performing further analysis on the extracted wavelets which are most likely to be associated with lane changes (i.e., wavelets 602(a) and 602(b)).

FIG. 6B illustrates how lane change detection system 310 can filter the wavelet-transformed vehicle motion signal using a power range pre-determined to indicate potential lane changes. Accordingly, lane change detection system 310 can extract wavelets that fall within this pre-determined power range (i.e., wavelets 602(a) and 602(b)) while removing wavelets (i.e., wavelet 602(c)) that fall outside (in whole in part) this pre-determined power range. As depicted by legend 612, relatively lighter colors may depict relatively higher powers in representation 602.

FIG. 6C illustrates how lane change detection system 310 can filter the wavelet-transformed vehicle motion signal using a period/duration range pre-determined to indicate potential lane changes. Accordingly, lane change detection system 310 can extract wavelets that fall within this pre-determined period/duration range (i.e., wavelets 602(a) and 602(b)) while removing wavelets (i.e., wavelet 602(c)) that fall outside (in whole in part) this pre-determined period/duration range.

As described above, in certain implementations lane change detection system 310 can determine the above-described frequency, power, and period/duration ranges based on historical lane change data (e.g., historical wavelet-transformed vehicle motion signals known to be associated with lane changes).

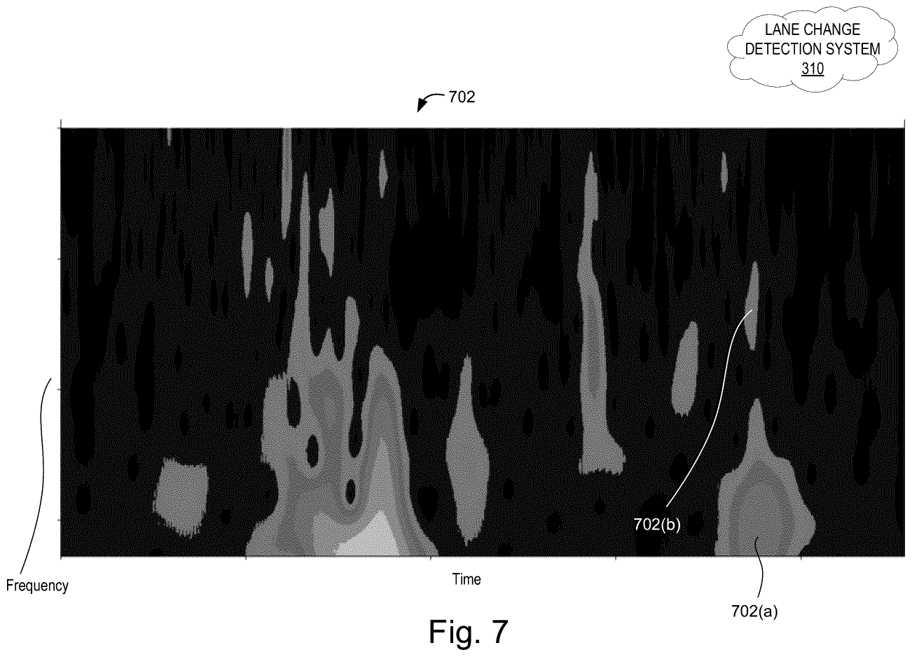

FIG. 7 depicts an example representation 702 of a wavelet-transformed vehicle motion signal associated with a vehicle changing lanes while traversing a curved road segment, in accordance with various embodiments of the presently disclosed technology.

Namely, a wavelet 702(a) may be associated with the vehicle traversing the curved road segment while wavelet 702(b) may be associated with the vehicle changing lanes while traversing the curved road segment. As illustrated by representation 702, by carefully selecting parameters for the wavelet transformation, these two wavelets may be clearly defined in the wavelet-transformed vehicle motion signal—which can make them easier to analyze. It may also be noted that wavelet 702(a) (associated with the vehicle traversing the curved road segment) has a lower frequency, a higher power, and a longer period/duration than wavelet 702(b) (associated with the lane change).

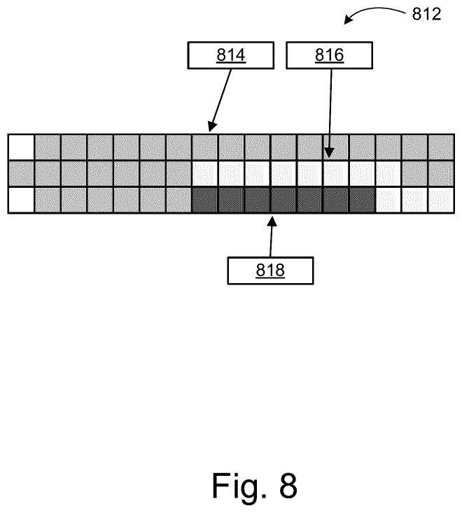

FIG. 8 illustrates an example lane-level traffic map 812, in accordance with various embodiments of the presently disclosed technology.

In the specific example of FIG. 8, lane-level traffic map 812 comprises three rows and numerous columns to signify locations within each lane of a road segment. Furthermore, lane-level traffic map 812 shows three distinct shades of grey. Namely, cells 814 are light grey to signify regions where traffic speed is traveling approximately at the speed limit. Cells 816 are white to signify regions where there is free flowing traffic. In other implementations, colors of lane-level traffic map 812 may reflect other parameters, such as density of traffic.

It should be appreciated that lane-level traffic map 812 is merely provided as an illustrative example, and does not limit the foregoing disclosure.

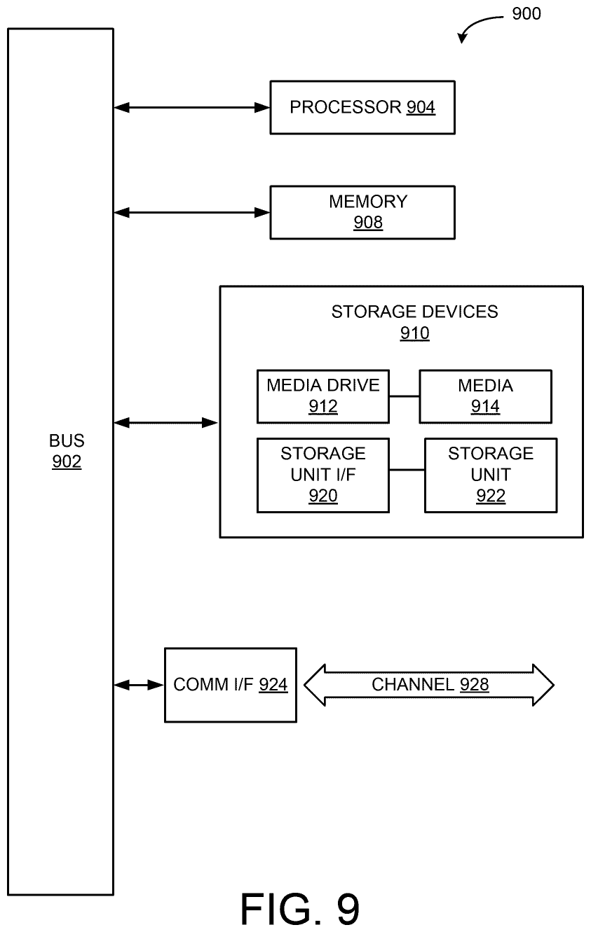

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 9. Various embodiments are described in terms of this example-computing component 900. After reading this description, it will become apparent to a person skilled in the relevant art how to implement the application using other computing components or architectures.

Referring now to FIG. 9, computing component 900 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 900 might also represent computing capabilities embedded within or otherwise available to a given device. For example, a computing component might be found in other electronic devices such as, for example, portable computing devices, and other electronic devices that might include some form of processing capability.

Computing component 900 might include, for example, one or more processors, controllers, control components, or other processing devices. This can include a processor, and/or any one or more of the components making up a user device, a user system, and a non-decrypting cloud service. Processor 904 might be implemented using a general-purpose or special-purpose processing engine such as, for example, a microprocessor, controller, or other control logic. Processor 904 may be connected to a bus 902. However, any communication medium can be used to facilitate interaction with other components of computing component 900 or to communicate externally.

Computing component 900 might also include one or more memory components, simply referred to herein as main memory 908. For example, random access memory (RAM) or other dynamic memory, might be used for storing information and instructions to be executed by processor 904. Main memory 908 might also be used for storing temporary variables or other intermediate information during execution of instructions to be executed by processor 904. Computing component 900 might likewise include a read only memory (“ROM”) or other static storage device coupled to bus 902 for storing static information and instructions for processor 904.

The computing component 900 might also include one or more various forms of information storage mechanism 910, which might include, for example, a media drive 912 and a storage unit interface 920. The media drive 912 might include a drive or other mechanism to support fixed or removable storage media 914. For example, a hard disk drive, a solid-state drive, a magnetic tape drive, an optical drive, a compact disc (CD) or digital video disc (DVD) drive (R or RW), or other removable or fixed media drive might be provided. Storage media 914 might include, for example, a hard disk, an integrated circuit assembly, magnetic tape, cartridge, optical disk, a CD or DVD. Storage media 914 may be any other fixed or removable medium that is read by, written to or accessed by media drive 912. As these examples illustrate, the storage media 914 can include a computer usable storage medium having stored therein computer software or data.

In alternative embodiments, information storage mechanism 910 might include other similar instrumentalities for allowing computer programs or other instructions or data to be loaded into computing component 900. Such instrumentalities might include, for example, a fixed or removable storage unit 922 and interface 920. Examples of such storage units 922 and interfaces 920 can include a program cartridge and cartridge interface, a removable memory (for example, a flash memory or other removable memory component) and memory slot. Other examples may include a PCMCIA slot and card, and other fixed or removable storage units 922 and interfaces 920 that allow software and data to be transferred from storage unit 922 to computing component 900.

Computing component 900 might also include a communications interface 924. Communications interface 924 might be used to allow software and data to be transferred between computing component 900 and external devices. Examples of communications interface 924 might include a modem or softmodem, a network interface (such as Ethernet, network interface card, IEEE 802.XX or another interface). Other examples include a communications port (such as for example, a USB port, IR port, RS232 port Bluetooth® interface, or other port), or other communications interfaces. Software/data transferred via communications interface 924 may be carried on signals, which can be electronic, electromagnetic (which includes optical) or other signals capable of being exchanged by a given communications interface 924. These signals might be provided to communications interface 924 via a channel 928. Channel 928 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 908, storage unit 920, media 914, and channel 928. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 900 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is target or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
transforming a vehicle motion signal into a frequency domain by applying a wavelet transformation to the vehicle motion signal, wherein the vehicle motion signal is associated with a vehicle traversing a road segment;
based on historical lane change data, filtering the wavelet-transformed vehicle motion signal to extract a wavelet as a potential lane change event; and
providing the extracted wavelet to an analytical model and using the analytical model to determine, based on the extracted wavelet, that the vehicle changed lanes while traversing the road segment.

2. The method of claim 1, further comprising:
transmitting information associated with the determined lane change to at least one of a lane-level traffic map generation system and an autonomous driving system.

3. The method of claim 1, further comprising, at least one of:
autonomously controlling at least one of the vehicle and a second vehicle traversing the road segment based on the determined lane change of the vehicle; or
updating a lane-level traffic map for the road segment based on the determined lane change of the vehicle.

4. The method of claim 1, wherein filtering the wavelet-transformed vehicle motion signal to extract the wavelet as the potential lane change event comprises at least one of:
extracting the wavelet because it falls within a power range pre-determined from the historical lane change data;
extracting the wavelet because it falls within a frequency range pre-determined from the historical lane change data; or
extracting the wavelet because it falls within a period range pre-determined from the historical lane change data.

5. The method of claim 4, wherein the historical lane change data comprises historical wavelet-transformed vehicle motion signals associated with known lane changes.

6. The method of claim 4, wherein the historical lane change data comprises historical wavelet-transformed vehicle motion signals associated with known lane changes on the road segment.

7. The method of claim 1, wherein:
transforming the vehicle motion signal into the frequency domain by applying the wavelet transformation to the vehicle motion signal comprises generating a first wavelet associated with the vehicle traversing a curve on the road segment and a second wavelet associated with the vehicle changing a lane while traversing the curve; and
filtering the wavelet-transformed vehicle motion signal to extract the wavelet as the potential lane change event comprises extracting only the second wavelet of the first and second wavelets.

8. The method of claim 7, further comprising determining the road segment comprises the curve, wherein:
generating the first wavelet associated with the vehicle traversing the curve and the second wavelet associated with the vehicle changing the lane while traversing the curve is responsive to determining the road segment comprises the curve.

9. The method of claim 1, wherein the vehicle motion signal is derived from at least one of:
lateral acceleration data of the vehicle as the vehicle traverses the road segment;
yaw rate data of the vehicle as the vehicle traverses the road segment;
heading data of the vehicle as the vehicle traverses the road segment;
accelerometer data of the vehicle as the vehicle traverses the road segment;
steering wheel angle data of the vehicle as the vehicle traverses the road segment; or
speed data of the vehicle as the vehicle traverses the road segment.

10. The method of claim 1, further comprising:
responsive to extracting the wavelet as the potential lane change event, providing, to the analytical model, non-wavelet data associated with the vehicle traversing the road segment;
wherein the analytical model also considers the non-wavelet data when determining the vehicle changed lanes while traversing the road segment.

11. The method of claim 10, wherein the non-wavelet data associated with the vehicle traversing the road segment comprises at least one of:
turning signal operation data acquired from the vehicle as the vehicle traverses the road segment;
lateral position data acquired from the vehicle as the vehicle traverses the road segment;
image data acquired from the vehicle as the vehicle traverses the road segment; or
image data capturing the vehicle, acquired from other vehicles proximate the vehicle as the other vehicles traverse the road segment with the vehicle.

12. The method of claim 11, wherein the image data capturing the vehicle, acquired from the other vehicles, comprises at least one of:
image data capturing operation of a turning signal of the vehicle; or
image data capturing lateral position of the vehicle relative to lane boundaries of the road segment.

13. The method of claim 1, further comprising:
filtering the vehicle motion signal based on historical lane change data to extract potential lane change events characterized by the vehicle motion signal;
wherein transforming the vehicle motion signal into the frequency domain by applying the wavelet transformation to the vehicle motion signal comprises only transforming the extracted potential lane change events characterized by the vehicle motion signal.

14. A system comprising:
one or more processors; and
memory storing machine-readable instructions that, when executed by the one or more processors, cause the system to:
responsive to determining a vehicle is traversing a road segment comprising a curve, applying a wavelet transformation to a vehicle motion signal associated with the vehicle traversing the road segment to decompose the vehicle motion signal into a first wavelet associated with the vehicle traversing the curve and a second wavelet associated with the vehicle changing lanes while traversing the curve; and
analyzing the second wavelet to determine the vehicle changed lanes while traversing the curve.

15. The system of claim 14, wherein the memory stores further machine-readable instructions that, when executed by the one or more processors, cause the system to:
transmit information associated with the determined lane change to at least one of a lane-level traffic map generation system and an autonomous driving system.

16. The system of claim 14, wherein the memory stores further machine-readable instructions that, when executed by the one or more processors, cause the system to, at least one of:
autonomously control at least one of the vehicle and a second vehicle traversing the road segment based on the determined lane change of the vehicle; or
update a lane-level traffic map for the road segment based on the determined lane change of the vehicle.

17. The system of claim 14, wherein the memory stores further machine-readable instructions that, when executed by the one or more processors, cause the system to:
based on historical lane change data, filter out the first wavelet prior to analyzing the second wavelet.

18. The system of claim 17, wherein filtering out the first wavelet based on the historical lane change data comprises determining the first wavelet falls outside at least one of:
a power range indicative of potential lane change events, the power range pre-determined from the historical lane change data;
a frequency range indicative of potential lane change events, the frequency range pre-determined from the historical lane change data; or
a period range indicative of potential lane change events, the period range pre-determined from the historical lane change data.

19. A method comprising:
transforming vehicle motion signals associated with known lane changes performed on curved road segments into a frequency domain by applying a wavelet transformation to the vehicle motion signals; and
using the wavelet-transformed vehicle motion signals to train a machine learning model to detect lane changes performed on curved road segments.

20. The method of claim 19, wherein transforming a respective vehicle motion signal associated comprises decomposing the respective vehicle motion signal into a first wavelet associated with a respective vehicle traversing a respective curved road segment and a second wavelet associated with the respective vehicle changing lanes while traversing the respective curved road segment.
